(19) United States
(12) Patent Application Publication
(10) Pub. No.: US 2026/0281023 A1
(43) Pub. Date: Sep. 17, 2026

(54) METHOD AND APPARATUS FOR PADDING OF PERFORMANCE MEASUREMENT FUNCTION PROTOCOL MESSAGE IN MOBILE COMMUNICATIONS

(71) Applicant: MEDIATEK INC., Hsinchu City (TW)

(72) Inventors: Yu-Hsin LIN, Hsinchu City (TW); Yuan-Chieh LIN, Hsinchu City (TW); Jeng-Yang KAO, Hsinchu City (TW)

(21) Appl. No.: 19/472,693

(22) PCT Filed: Sep. 14, 2024
(86) PCT No.: PCT/CN2024/119085

§ 371 Date: Oct. 5, 2025

Related U.S. Application Data
(60) Provisional application No. 63/587,171, filed on Oct. 2, 2023.

(51) Int. Cl. H04L 43/0864; H04W 24/10

(52) U.S. Cl. CPC H04L 43/0864; H04W 24/10

(57) ABSTRACT

Various solutions for padding of performance measurement function protocol (PMFP) message with respect to user equipment and network apparatus in mobile communications are described. An apparatus may generate a first PMFP message. The first PMFP message may comprise a first padding value field. The apparatus may encode the first padding value field with a random value. The apparatus may send the first PMFP message to a network node.

### CROSS REFERENCE TO RELATED PATENT APPLICATION(S)

The present disclosure is part of a non-provisional application claiming the priority benefit of U.S. Patent Application No. 63/587,171, filed 2 Oct. 2023, the content of which herein being incorporated by reference in its entirety.

### TECHNICAL FIELD

The present disclosure is generally related to mobile communications and, more particularly, to padding of performance measurement function protocol (PMFP) message with respect to user equipment and network apparatus in mobile communications.

### BACKGROUND

Unless otherwise indicated herein, approaches described in this section are not prior art to the claims listed below and are not admitted as prior art by inclusion in this section.

Access Traffic Steering, Switching and Splitting (ATSSS) is a feature in the 3rd generation partnership project (3GPP) standards, which enables traffic steering across multiple accesses, including a 3GPP access (e.g., fifth generation (5G) cellular network) and a non-3GPP access (e.g., WiFi network). For example, the ATSSS capable user equipment (UE) is able to perform access performance measurements to decide how to distribute traffic over 3GPP access and non-3GPP access. The messages for round trip time (RTT) measurement are sent between the UE and the user plane function (UPF). How to generate and process such messages in a more efficient way becomes an important issue in the ATSSS supported communication system.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to padding of performance measurement function protocol (PMFP) message with respect to user equipment (UE) and network apparatus in mobile communications.

In one aspect, a method may involve an apparatus generating a first PMFP message. The first PMFP message may comprise a first padding value field. The method may also involve the apparatus encoding the first padding value field with a random value. The method may further involve the apparatus sending the first PMFP message to a network node.

In one aspect, an apparatus may comprise a transceiver which, during operation, wirelessly communicates with a network node. The apparatus may also comprise a processor communicatively coupled to the transceiver. The processor, during operation, may perform operations comprising generating a first PMFP message. The first PMFP message may comprise a first padding value field. The processor may also perform operations comprising encoding the first padding value field with a random value. The processor may further perform operations comprising sending the first PMFP message to a network node via the transceiver.

In another aspect, a method may involve a network node generating a first PMFP message. The first PMFP message may comprise a first padding value field. The method may also involve the network node encoding the first padding value field with a random value. The method may further involve the network node sending the first PMFP message to a UE.

It is noteworthy that, although description provided herein may be in the context of certain radio access technologies, networks and network topologies such as LTE, LTE-Advanced, LTE-Advanced Pro, 5G, NR, 5G-Advanced, Internet-of-Things (IOT), Narrow Band Internet of Things (NB-IoT), Industrial Internet of Things (IloT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting a padding information element (IE) of performance measurement function protocol (PMFP) message in accordance with implementations of the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to padding of performance measurement function protocol (PMFP) message in mobile communications, so that the user equipment (UE) and the network node can operate more efficiently during PMFP procedures by avoiding unnecessary consumption of computing resources. According to the present disclosure, a number of possible solutions may be implemented separately or jointly. That is, although these possible solutions may be described below separately, two or more of these possible solutions may be implemented in one combination or another.

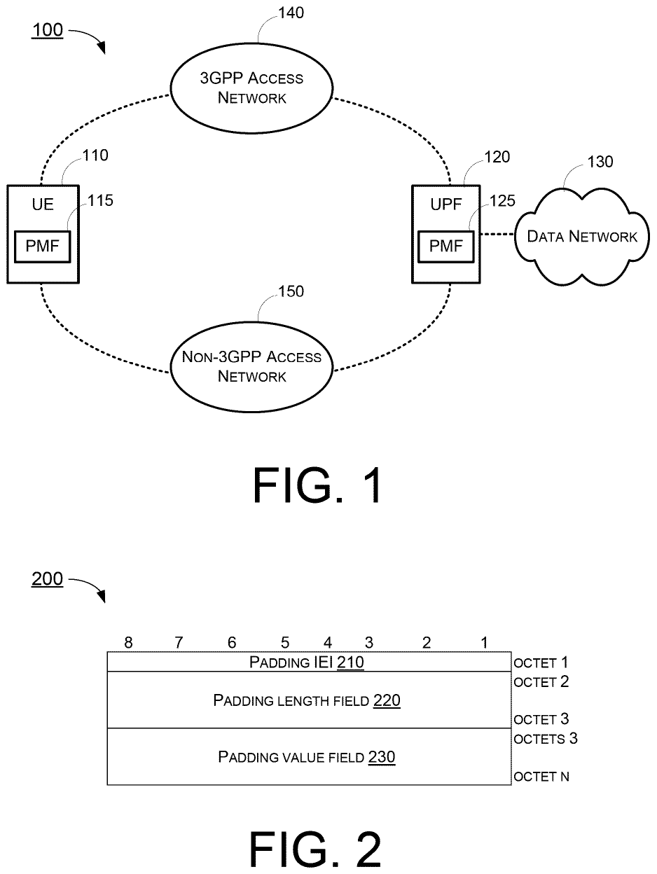

FIG. 1 is a diagram depicting an example scenario of a communication environment in which various solutions and schemes in accordance with the present disclosure may be implemented. In scenario 100, Access Traffic Steering, Switching and Splitting (ATSSS) functionalities can be supported by a UE 110 and a user plane function (UPF) 120. The ATSSS functionalities enable a multi-access protocol data unit (PDU) connectivity service, which can exchange PDUs between the UE 110 and a data network 130 by simultaneously using a 3rd generation partnership project (3GPP) access network 140 and a non-3GPP access network 150. The multi-access PDU connectivity service is realized by establishing a multi-access PDU session. That is, a PDU session that can have user-plane resources on both of the 3GPP access network 140 and the non-3GPP access network 150. In one embodiment, the 3GPP access network 140 may comprise one or more base stations (e.g., gNBs/eNBs) providing radio access for the UE 110 via various 3GPP radio access technologies (RATs) including but not limited to 6G, 5G, 4G, and 3G/2G, where the non-3GPP access network 150 may comprise access points (APs) providing radio access for UE 110 via non-3GPP RAT, such as WiFi.

In one embodiment, the PMFP procedures are performed between a performance measurement function (PMF) 115 in the UE 110 and a PMF 125 in the UPF 120 to measure the performance between the PMFs 115 and 125. For example, the UE 110 and the UPF 120 may transmit PMFP messages to each other to measure the round-trip time (RTT) of user data packets exchanged between the UE 110 and the UPF 120. The PMFP message may be a PMFP echo request message or a PMFP echo response message. In an event that the upper layers request a particular length of the PMFP message, a padding scheme should be applied to enlarge the PMFP message. As shown in FIG. 2, the padding information element (IE) 200 is included the PMFP message, in which the padding IE 200 comprises a padding information element identifier (IEI) 210, a padding length field 220, and a padding value field 230. In this embodiment, the padding value field 230 of the padding IE 200 is encoded with a random value. The random value is, for example, a non-zero random value. In other words, the sending entity (i.e., the entity sending out the PMFP message, may be either the UE 110 or the UPF 120) may allocate a memory for the padding value field 230 without setting any initial values. This can avoid wasting computing resources due to encoding the padding value field with a particular value.

In one embodiment, when the UE 110 wants to measure the RTT of an exchange of user data packets between the UE 110 and the UPF 120, the UE 110 may initiate an RTT measurement procedure. A PMFP echo request message is generated accordingly. The PMFP echo request message may include a padding IE (e.g., padding IE 200). The padding value field of the padding IE is encoded with a random value (e.g., a non-zero random value) by the UE 110, and then the PMFP echo request message is sent to the UPF 120. Once receiving the PMFP echo request message sent from the UE 110, the UPF 120 may generate a PMFP echo response message corresponding to the received PMFP echo request message. The PMFP echo response message may also include a padding IE (e.g., padding IE 200), in which the padding value field of the padding IE is encoded with any value (e.g., a non-zero random value) by the UPF 120. The UPF 120 sends the PMFP echo response message to the UE 110. The UE 110 may ignore the padding value field of the received PMFP echo response message.

In another embodiment, the UPF 120 may also initiate an RTT measurement procedure including generating and sending a PMFP echo request message to the UE 110. The PMFP echo request message generated by the UPF 120 may include a padding IE (e.g., padding IE 200), with the padding value field encoded with a random value (e.g., a non-zero random value). After the UE 110 receives the PMFP echo request message from the UPF 120, the UE 110 generates a corresponding PMFP echo response message, encodes the padding value field of the PMFP echo response message with any value (e.g., a non-zero random value), and sends the PMFP echo response message to the UPF 120. It should be noted that the padding value field in the PMFP echo response message is ignored by the UPF 120.

### Illustrative Implementations

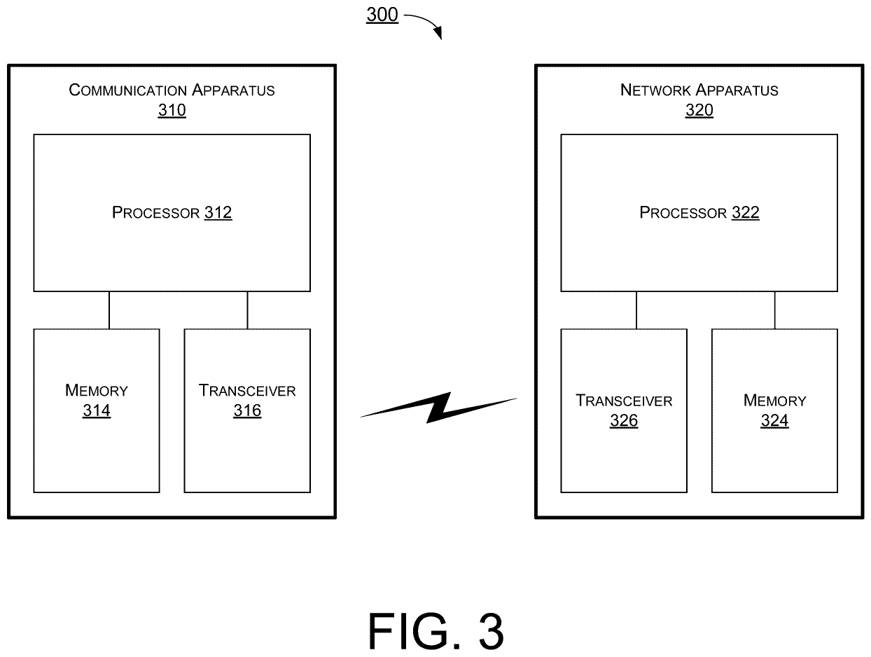

FIG. 3 illustrates an example communication system 300 having at least an example communication apparatus 310 and an example network apparatus 320 in accordance with an implementation of the present disclosure. Each of the communication apparatus 310 and network apparatus 320 may perform various functions to implement schemes, techniques, processes and methods described herein pertaining to padding of PMFP message in mobile communications, including scenarios/schemes described above as well as process 400 and process 500 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a network entity supporting one or a combination of network functions (NFs). The NFs comprise, but not limited to, access and mobility management function (AMF), session management function (SMF), unified data management (UDM), and user plane function (UPF). Alternatively, network apparatus 320 may be a base station and/or a UPF. Network apparatus 320 may include at least some of those components shown in FIG. 3 such as a processor 322, for example. Processor 322 may further include protocol stacks and a set of control functional modules and circuit. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of the processor 312 and processor 322 may be implemented in the form of one or more single-core processors, one or more multi-core processors, or one or more CISC processors. That is, even though a singular term “a processor” is used herein to refer to processor 312 and processor 322, each of the processor 312 and processor 322 may include multiple processors in some implementations and a single processor in other implementations in accordance with the present disclosure. In another aspect, each of the processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 312 and processor 322 is a special-purpose machine specifically designed, arranged and configured to perform specific tasks in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein.

In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively.

For illustrative purposes and without limitation, descriptions of capabilities of the communication apparatus 310 and network apparatus 320 are provided below with process 400 and process 500. In which, the communication apparatus 310 is implemented in or as a communication apparatus or a UE, and network apparatus 320 is implemented in or as a network node of a communication network.

### Illustrative Processes

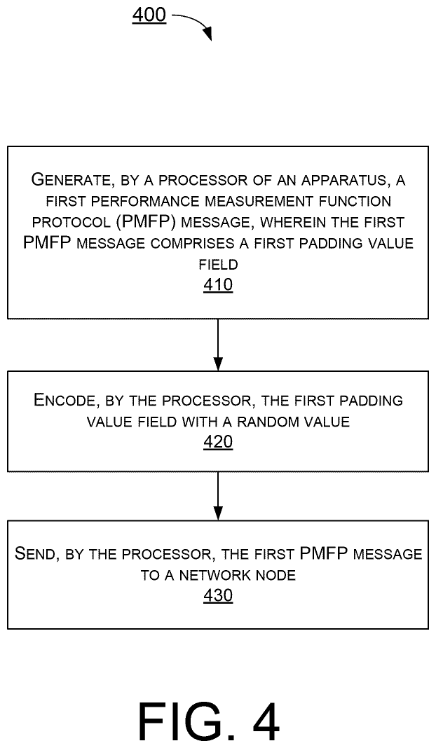

FIG. 4 illustrates an example process 400 in accordance with an implementation of the present disclosure. Process 400 may be an example implementation of above scenarios/schemes, whether partially or completely, with respect to padding of PMFP message in mobile communications. Process 400 may represent an aspect of implementation of features of communication apparatus 310. Process 400 may include one or more operations, actions, or functions as illustrated by one or more of blocks 410, 420, and 430. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310 as a UE. Process 400 may begin at block 410.

At block 410, process 400 may involve processor 312 of communication apparatus 310 generating a first PMFP message. The first PMFP message may comprise a first padding value field. Process 400 may proceed from block 410 to block 420.

At block 420, process 400 may involve processor 312 encoding the first padding value field with a random value. Process 400 may proceed from block 420 to block 430.

At block 430, process 400 may involve processor 312 sending the first PMFP message to a network node (e.g., network apparatus 320) via transceiver 316.

In some implementations, process 400 may further involve processor 312 receiving a second PMFP message from the network node via transceiver 316. The second PMFP message corresponds to the first PMFP message and comprises a second padding value field. Also, process 400 may involve processor 312 ignoring the second padding value field.

In some implementations, the second padding value field is encoded with an any value by the network node.

In some implementations, the second padding value field is encoded with a non-zero random value by the network node.

In some implementations, the first PMFP message is a PMFP echo request message, and the second PMFP message is a PMFP echo response message.

In some implementations, the first PMFP message is a PMFP echo response message, and the second PMFP message is a PMFP echo request message.

In some implementations, the random value for encoding the first padding value field by communication apparatus 310 is a non-zero random value.

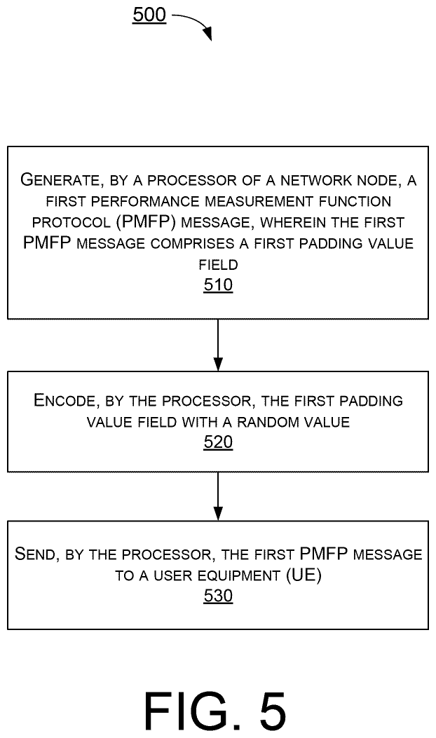

FIG. 5 illustrates another example process 500 in accordance with an implementation of the present disclosure. Process 500 may be an example implementation of above scenarios/schemes, whether partially or completely, with respect to padding of PMFP message in mobile communications. Process 500 may represent an aspect of implementation of features of network apparatus 320. Process 500 may include one or more operations, actions, or functions as illustrated by one or more of blocks 510, 520, and 530. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may begin at block 510.

At block 510, process 500 may involve processor 322 of network apparatus 320 generating a first PMFP message. The first PMFP message may comprise a first padding value field. Process 500 may proceed from block 510 to block 520.

At block 520, process 400 may involve processor 322 encoding the first padding value field with a random value. Process 500 may proceed from block 520 to block 530.

At block 530, process 500 may involve processor 322 sending the first PMFP message to a UE (e.g., communication apparatus 310) via transceiver 326.

In some implementations, process 500 may further involve processor 322 receiving, via transceiver 326, a second PMFP message from the UE. The second PMFP message corresponds to the first PMFP message and comprises a second padding value field. Also, process 400 may involve processor 322 ignoring the second padding value field.

In some implementations, the second padding value field is encoded with an any value by the UE.

In some implementations, the second padding value field is encoded with a non-zero random value by the UE.

In some implementations, the first PMFP message is a PMFP echo request message, and the second PMFP message is a PMFP echo response message.

In some implementations, the first PMFP message is a PMFP echo response message, and the second PMFP message is a PMFP echo request message.

In some implementations, the random value for encoding the first padding value field by network apparatus 320 is a non-zero random value.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating, by a processor of an apparatus, a first performance measurement function protocol (PMFP) message, wherein the first PMFP message comprises a first padding value field;
encoding, by the processor, the first padding value field with a random value; and
sending, by the processor, the first PMFP message to a network node.

2. The method of claim 1, further comprising:
receiving, by the processor, a second PMFP message from the network node, wherein the second PMFP message corresponds to the first PMFP message and comprises a second padding value field; and
ignoring, by the processor, the second padding value field.

3. The method of claim 2, wherein the second padding value field is encoded with an any value by the network node.

4. The method of claim 2, wherein the second padding value field is encoded with a non-zero random value by the network node.

5. The method of claim 2, wherein the first PMFP message is a PMFP echo request message, and the second PMFP message is a PMFP echo response message.

6. The method of claim 2, wherein the first PMFP message is a PMFP echo response message, and the second PMFP message is a PMFP echo request message.

7. The method of claim 1, wherein the random value is a non-zero random value.

8. An apparatus, comprising:
a transceiver which, during operation, communicates wirelessly; and
a processor communicatively coupled to the transceiver such that, during operation, the processor performs operations comprising:
generating a first performance measurement function protocol (PMFP) message, wherein the first PMFP message comprises a first padding value field;
encoding the first padding value field with a random value; and
sending, via the transceiver, the first PMFP message to a network node.

9. The apparatus of claim 8, wherein during operation, the processor further performs operations comprising:
receiving, via the transceiver, a second PMFP message from the network node, wherein the second PMFP message corresponds to the first PMFP message and comprises a second padding value field; and
ignoring the second padding value field.

10. The apparatus of claim 9, wherein the second padding value field is encoded with an any value by the network node.

11. The apparatus of claim 9, wherein the first PMFP message is a PMFP echo request message, and the second PMFP message is a PMFP echo response message.

12. The apparatus of claim 9, wherein the first PMFP message is a PMFP echo response message, and the second PMFP message is a PMFP echo request message.

13. The apparatus of claim 8, wherein the random value is a non-zero random value.

14. A method, comprising:
generating, by a processor of a network node, a first performance measurement function protocol (PMFP) message, wherein the first PMFP message comprises a first padding value field;
encoding, by the processor, the first padding value field with a random value;
sending, by the processor, the first PMFP message to a user equipment (UE).

15. The method of claim 14, further comprising:
receiving, by the processor, a second PMFP message from the UE, wherein the second PMFP message corresponds to the first PMFP message and comprises a second padding value field; and
ignoring, by the processor, the second padding value field.

16. The method of claim 15, wherein the second padding value field is encoded with an any value by the UE.

17. The method of claim 15, wherein the second padding value field is encoded with a non-zero random value by the UE.

18. The method of claim 15, wherein the first PMFP message is a PMFP echo request message, and the second PMFP message is a PMFP echo response message.

19. The method of claim 15, wherein the first PMFP message is a PMFP echo response message, and the second PMFP message is a PMFP echo request message.

20. The method of claim 14, wherein the random value is a non-zero random value.
